(19) United States
(12) Patent Application Publication
(10) Pub. No.: US 2008/0207249 A1
(43) Pub. Date: Aug. 28, 2008

(54) APPARATUS AND METHOD FOR CONTROLLING POWER IN A WIRELESS MOBILE COMMUNICATION SYSTEM

(75) Inventors: Ji-Hoon CHOI, Suwon-si (KR); Sung-Kwon JO, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/036,508

(22) Filed: Feb. 25, 2008

(30) Foreign Application Priority Data
Feb. 23, 2007 (KR) 2007-18417

(51) Int. Cl. H04B 7/00

(52) U.S. Cl. 455/522

(57) ABSTRACT

An apparatus and method for controlling power in a wireless mobile communication system are provided. The apparatus and method efficiently adjusts a threshold value in order to control closed-loop power through an outer-loop power control in a wireless mobile communication system. Accordingly, it is possible to increase cell capacity while link performance is stably maintained.

### PRIORITY

This application claims the benefit under 35 U.S.C. §119(a) to a Korean patent application filed with the Korean Intellectual Property Office on Feb. 23, 2007 and assigned Serial No. 2007-18417, the entire disclosure of which is hereby incorporated by reference.

### BACKGROUND OF THE INVENTION

1. Field of the Invention

The present invention relates to power control in a wireless mobile communication system. More particularly, the present invention relates to a method for increasing cell capacity while stably maintaining link performance by efficiently adjusting a threshold (i.e. a set point) for power control.

2. Description of the Related Art

In a wireless mobile communication system, the power used to transmit signals is controlled. When controlling the signal power, it is desired to reduce interference between signals in a multiple access system and, at the same time, maintain the quality of a data channel above a predetermined level. The power control may be applied to both forward links and reverse links. Methods of controlling power may be classified into open-loop, closed-loop and outer-loop schemes, wherein the power control of a system may be implemented using all or some of the three schemes.

The three power control methods for the reverse link when an access terminal (AT) is in a handoff situation will now be described.

FIG. 1 is a block diagram illustrating a conventional power control scheme for the reverse link when an AT is in a handoff situation.

### (1) Open-Loop Power Control

In FIG. 1, a receiver of an AT 110 measures average reception power of pilot signals received from base transceiver station (BTS) BTS-A 120 and BTS-B 130. The AT 110 sets the transmission power of a pilot signal, to be transmitted through each reverse link, to a value which is inversely proportional to the average power of the pilot signals of each corresponding forward link. That is, when the reception power of a forward-link pilot signal is large, it means that the performance of the link between the AT and a BTS is good, so that the AT reduces the transmission power for a corresponding reverse-link pilot signal. In contrast, when the reception power of a forward-link pilot signal is small, it means that the performance of the link between the AT and a BTS is poor, so that the AT increases the transmission power for a corresponding reverse-link pilot signal. Through such a procedure, the average powers of pilot signals received by the BTS-A 120 and the BTS-B 130 are maintained at a predetermined level, regardless of the position of the AT 110.

### (2) Closed-Loop Power Control

The average power of signals received by a BTS from each AT varies depending on a difference in channel characteristics between a forward link and a reverse link, an error in estimation of pilot signal reception power by each AT, etc. In order to compensate for such a power difference between ATs, the BTS-A 120 or the BTS-B 130 of FIG. 1 estimates a signal-to-noise ratio (SNR) of a pilot signal received from each AT 110, and creates a reverse power control (RPC) bit by comparing the estimated SNR with a threshold established by the BTS-A 120 or the BTS-B 130, respectively. That is, when the estimated SNR is greater than the threshold, the BTS sets the RPC bit to “1” (i.e. down). In contrast, when the estimated SNR is less than the threshold, the BTS sets the RPC bit to “0” (i.e. up). Then, the BTS transmits the RPC bit to the AT via a forward link so that the AT 110 can control its pilot transmission power. In FIG. 1, since the AT 110 is in the handoff situation, the AT 110 receives RPC bits from the BTS-A 120 and the BTS-B 130 at the same time. In this case, when both the RPC bits received from the BTS-A 120 and from the BTS-B 130 have a value of “0,” the AT 110 increases its transmission power. In contrast, when at least one of the RPC bits has a value of “1,” the AT 110 decreases its transmission power.

### (3) Outer-Loop Power Control (OLPC)

A threshold used in a closed-loop power control changes over time in consideration of a moving speed of an AT, a channel state, a data rate of the AT, etc. According to an outer-loop power control scheme, it is possible to actively control the threshold for power control in consideration of a temporal change of the reverse data reception performance of a BTS. Referring to FIG. 1, packet information received by the BTS-A 120 and the BTS-B 130 is transmitted to a base station controller (BSC) 140. The BSC 140 combines the packet information received from the two BTSs 120 and 130, decreases the power control threshold when packets have been normally received, and increases the power control threshold when packets have not been normally received. A threshold newly calculated by the BSC 140 is transmitted to the BTS-A 120 and the BTS-B 130 so as to be used for the closed-loop power control.

FIG. 2 is a view illustrating a conventional OLPC algorithm used for a reverse link in a CDMA 1xEV-DO system.

A no-data state 210 represents a state where an AT maintains a reverse link contact state and does not transmit data. Since the threshold adjustment by outer-loop power control is achieved using data received from each AT, as described above, the threshold cannot be normally adjusted in the no-data state 210 where there is no data received by the BTS. Therefore, in the no-data state 210, the power control threshold (PCT) periodically increases by a predetermined amount (i.e. PCT=PCT+NoDataAutoUp) in order to conservatively ensure the data reception performance. In the no-data state 210, a state transition is performed into an inactive state 220 when the reverse link connection of the AT is disconnected, for example after a dormancy time out, and a state transition is performed into a data start state 230 when data is received from the AT.

The inactive state 220 represents a state where an AT and a BTS are disconnected, so that an outer-loop power control algorithm does not operate. In the inactive state 220, when a call between the AT and the BTS is established so that the outer-loop power control algorithm starts, the PCT is initialized (i.e. PCT=InitialSetpoint), and a state transition is performed into a normal state 240.

The data start state 230 represents a state where an AT, which has been in the no-data state 210, starts transmitting data. If the AT has stayed in the no-data state 210 for a long time, the value of the PCT has been increased. Accordingly, the value of the PCT may be larger then it needs to be. Therefore, in the data start state 230, when a packet is normally received, the value of the PCT decreases by a decrement of “DataStartDown”. In contrast, when an error occurs in a received packet, it means that the threshold is appropriate, so that a state transition is performed into the normal state 240.

In the normal state 240, the threshold is changed according to whether a packet has been normally received. That is, the value of the PCT decreases by a decrement of “NormalDown” when a packet is normally received, and the value of the PCT increases by an increment of “NormalUp” when an error occurs in a received packet. In this case, a relationship between a target packet error rate (PER) and the “NormalUp/NormalDown” is defined by Equation 1 below.

$$target PER = \frac{NormalDown}{NormalDown + NormalUp} \qquad ( 1 )$$

In the normal state 240, when data is not received for a predetermined period of time, a state transition is performed into the no-data state 210.

FIG. 3 is a flowchart illustrating the operation of a conventional BTS in the no-data state.

When a BTS has not received data for a predetermined period of time in the normal state in step 301 and thus is shifted into the no-data state, the BTS initializes the value of PCT_{—}0 to a current PCT value in step 302. Then, in step 303, the BTS determines if data is received through each frame. When it is determined in step 303 that data is not received, the BTS proceeds to step 304, and when it is determined in step 303 that data is received, the BTS proceeds to step 306 where the BTS is shifted into the data start state. In step 304, the BTS increases the value of the PCT by the increment of “NoDataAutoUp” in order to conservatively establish the power control threshold. Next, in step 305, the BTS restricts the maximum value of the PCT by using two maximum values (i.e. PCT+0+MaxIncreaseNoData and MaxPCTNoData), as shown in Equation 2 below, in order to prevent the PCT from excessively increasing in the no-data state. Then, the BTS returns to step 303, thereby repeating the aforementioned steps.

PCT=min (PCT, PCT_{—}0+MaxIncreaseNoData, MaxPCTNoData) (2)

According to the aforementioned outer-loop power control algorithm, when the AT does not transmit data for a predetermined period of time or more, the AT is shifted into the no-data state. In this case, since the BSC receives no packet information, it is impossible to adjust the power control threshold unlike in the normal state. However, the AT can start transmitting data at any time in the no-data state. In the case where the threshold is not adjusted but is maintained in the no-data state without being changed, if a channel state becomes poor due to movement of the AT or the like, the PER may temporarily increase when the AT starts transmitting data. In order to alleviate such a problem, the conventional outer-loop power control algorithm employs a method of periodically increasing the power control threshold in the no-data state. Even when the AT connected to the BTS does not receive data, the AT transmits a pilot signal and a control channel through a reverse link in order to maintain the link contact state, wherein the pilot signal and the control channel act as interference to other ATs. Therefore, in the case of using the conventional outer-loop power control algorithm, when a great number of ATs are in the no-data state while only some ATs transmit reverse data, the values of the power control thresholds of ATs currently in the no-data state increase unnecessarily, thereby increasing the amount of interference applied to the ATs transmitting data. As a result, there is a problem in that the capacity of the reverse links decreases.

### SUMMARY OF THE INVENTION

As aspect of the present invention is to address the above-mentioned problems and/or disadvantages and to provide at least the advantages described below. Accordingly, an aspect of the present invention is to provide a method for increasing cell capacity while stably maintaining link performance by efficiently adjusting the threshold for closed-loop power control through outer-loop power control in a wireless mobile communication system.

In accordance with an aspect of the present invention, a method for controlling, by a base transceiver station (BTS), transmission power of an access terminal (AT) in an outer-loop power control scheme in a wireless mobile communication system is provided. The method comprises, when a packet is not received from the AT for a period of time in a normal state where a call is established between the BTS and the AT, performing a state transition into a no-data state and periodically decreasing a power control threshold value by a first value, and when the BTS starts receiving a packet from the AT in the no-data state, increasing the power control threshold value by a second value and performing a state transition into a data start state.

In accordance with another aspect of the present invention, a method for controlling power by a base transceiver station (BTS) in a wireless mobile communication system is provided. The method comprises comparing the number of times of packet reception from an access terminal (AT) with a number of packet transmission times during a data start state where the BTS receives a packet from the AT, decreasing a power control threshold value by a first value when the number of times of the packet reception from an access terminal (AT) is equal to or less than the number of packet transmission times and performing a state transition into a normal state where a call is established between the BTS and the AT when the number of times of the packet reception from an access terminal (AT) exceeds the number of packet transmission times.

In accordance with still another aspect of the present invention, a method for controlling power by a base transceiver station (BTS) in a wireless mobile communication system is provided. The method comprises increasing or decreasing a power control threshold value by a first value at an interval during a no-data state where the BTS is linked to an access terminal (AT) and a transmitted/received packet does not exist and increasing the power control threshold value by a second value and performing a state transition into a data start state when packet transmission/reception is started between the BTS and AT.

In accordance with yet another aspect of the present invention, a method for controlling power by a base transceiver station (BTS) in a wireless mobile communication system is provided. The method comprises receiving a packet from an access terminal (AT) in a normal state where a call is established between the BTS and the AT, determining if the packet is normally decoded, decreasing a power control threshold value by a first value when the packet has been successfully decoded and the number of transmission times of the packet is equal to or less than a number of transmission times, determining if the packet corresponds to a final subpacket when the decoding of the packet fails and increasing the power control threshold value by a second value, either when the packet corresponds to the final subpacket or when the number of transmission times of the packet exceeds the number of transmission times.

In accordance with still another aspect of the present invention, an apparatus for controlling power in a wireless mobile communication system is provided. The apparatus comprises a state transition controller for outputting state transition information for a state transition control by using a number of packet transmission times, parameter information, and information about decoded packets and a power control threshold (PCT) controller for receiving the number of packet transmission times, the parameter information, the information about decoded packets, and the state transmission information, and for adjusting a power control threshold value.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a conventional power control scheme for the reverse link when an AT is in a handoff situation;

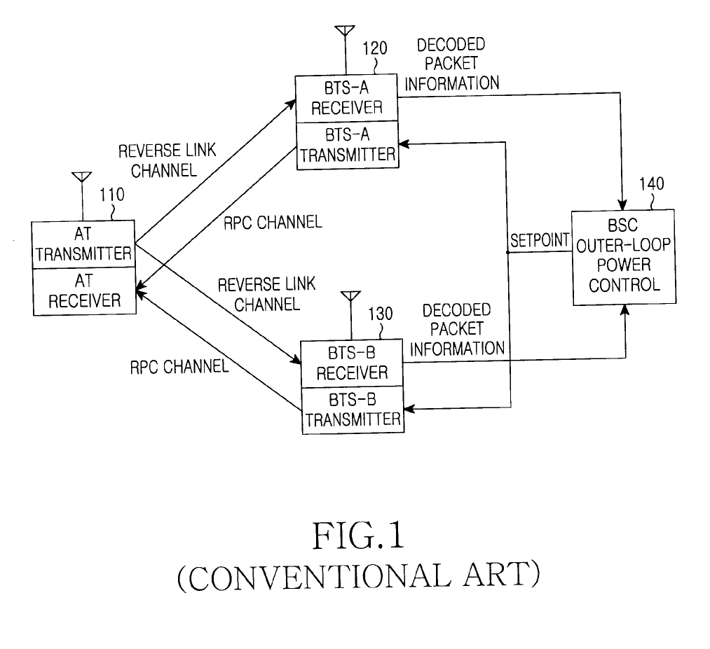

FIG. 2 is a view illustrating a conventional outer-loop power control (OLPC) algorithm used for a reverse link in a CDMA 1xEV-DO system;

FIG. 3 is a flowchart illustrating a conventional operation in a no-data state;

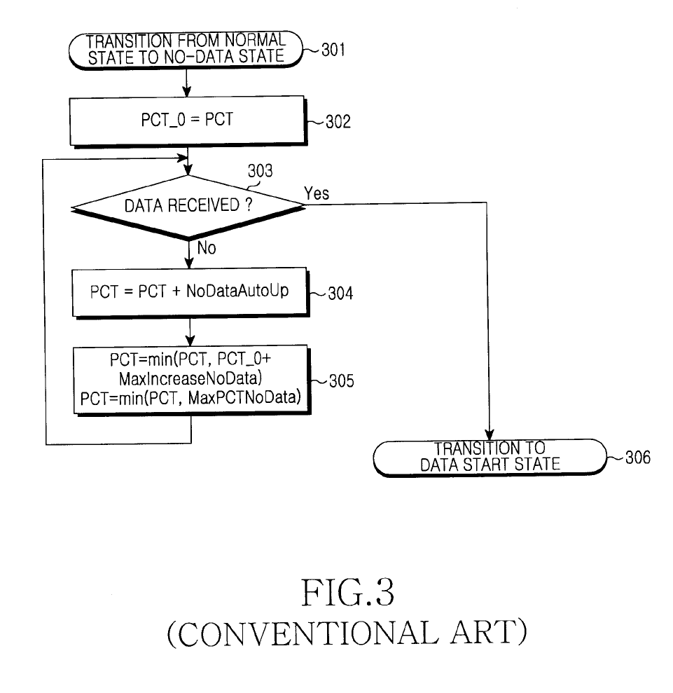

FIG. 4 is a view illustrating an OLPC algorithm according to an exemplary embodiment of the present invention;

FIG. 5 is a flowchart illustrating the operation in a no-data state according to an exemplary embodiment of the present invention;

FIG. 6 is a flowchart illustrating the operation in a normal state according to an exemplary embodiment of the present invention;

FIG. 7 is a view illustrating the method of boosting the gains of a data channel and an RRI channel according to an exemplary embodiment of the present invention; and

FIG. 8 is a block diagram illustrating the configuration of a power control apparatus according to an exemplary embodiment of the present invention.

Throughout the drawings, it should be noted that like reference numbers are used to depict the same or similar elements, features and structures

### DETAILED DESCRIPTION OF EXEMPLARY EMBODIMENTS

The following description with reference to the accompanying drawings is provided to assist in a comprehensive understanding of exemplary embodiment of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Terms described in the following description are defined by taking functions thereof into consideration, so they may vary according to users, operator's intention, or custom. Accordingly, the terms must be defined based on the entire contents of the present application.

Although the following description of the power control method according to exemplary embodiments of the present invention is described with reference to a CDMA 1xEV-DO Rev.A system (hereinafter, referred to as a “DO Rev.A”) as an example, the present invention is not limited thereto, but can be applied to other communication systems, as well.

In the DO Rev.A, one packet is divided into four subpackets by applying a hybrid automatic repeat request (H-ARQ) scheme. When a transmitter transmits the four subpackets one by one, and a receiver successfully receives all the subpackets, the transmitter transmits a new packet. Otherwise, the transmitter re-transmits a next subpacket. In the DO Rev.A, the number of times of subpacket transmissions for satisfying a target packet error rate (PER) is preset, and is called a “termination target.” That is, since one subpacket is transmitted in each of the four slots, the termination target is set to 8 when it is desired to satisfy a target PER through two subpacket transmissions, and the termination target is set to 16 when it is desired to satisfy a target PER by of subpacket transmissions. In the DO Rev.A, power control is performed to satisfy a preset termination target.

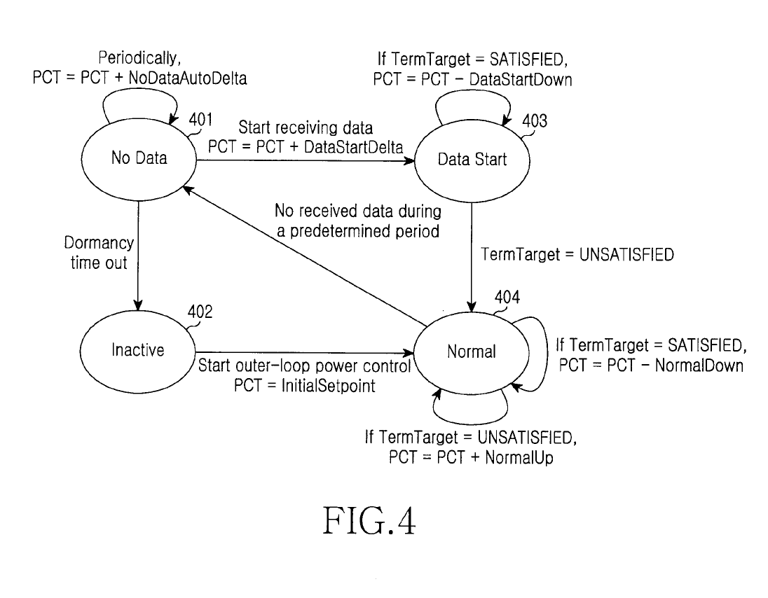

FIG. 4 is a view illustrating an outer-loop power control algorithm according to an exemplary embodiment of the present invention.

In a no-data state 401, an increment of “NoDataAutoDelta” is added to a PCT (i.e. PCT=PCT+NoDataAutoDelta). In this case, the NoDataAutoDelta has a positive value or a negative value according to the termination target. Generally, when the termination target has a value less than a threshold, the NoDataAutoDelta is set to a positive value, as in the conventional outer-loop power control algorithm, because there is a high possibility that a packet sensitive to transmission delay is to be transmitted. In contrast, when the termination target has a value greater than the threshold, the NoDataAutoDelta is set to a negative value.

When the NoDataAutoDelta is set to a negative value, the value of the PCT periodically decreases while the AT operates in the no-data state 401, so that the AT reduces power used for a pilot signal and a control channel, which the AT transmits to maintain a connection with the BTS. Accordingly, when a plurality of ATs are in the no-data state 401, interference by signals of ATs currently in the no-data state 401 is reduced, so that the transmission capacity of an AT which transmits data in a normal state 404 increases.

In the no-data state 401, when the connection between an AT and the BTS is terminated, for example after a dormancy time out, the AT is shifted into an inactive state 402. Also, when the BTS receives a packet from an AT currently in the no-data state 401, the BTS adds an increment of “DataStartDelta” to the PCT, and then is shifted into a data start state 403. In this case, when the NoDataAutoDelta has a positive value, the DataStartDelta is set to zero, and the same operation as that of the conventional outer-loop power control algorithm is performed. In contrast, when the NoDataAutoDelta has a negative value, the DataStartDelta is set to a positive number, thereby increasing the value of the PCT. Through such a setting, in the no-data state 401, when an AT transmits a packet in a state where the PCT value is reduced, the PCT value increases immediately, thereby minimizing the performance degradation of a data channel.

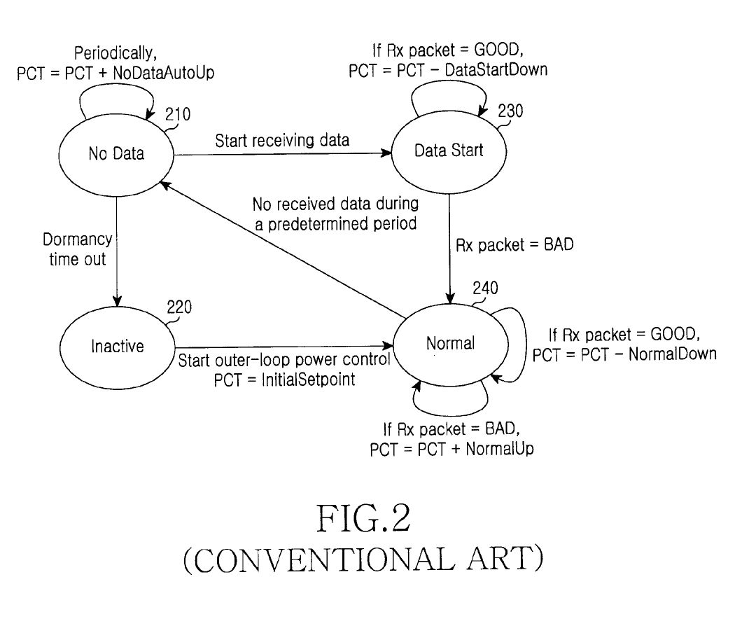

The operation in the inactive state 402 is substantially the same as that in the conventional outer-loop power control algorithm, shown in FIG. 2. That is, when a call between an AT and a BTS is established, the BTS initializes the PCT and is shifted into the normal state 404.

In the data start state 403, it is determined if a received packet satisfies a termination target. When the received packet satisfies a termination target (i.e. TermTarget=SATISFIED), the value of the PCT deceases by a decrement of “DataStartDown” (i.e. PCT=PCT−DataStartDown), and the data start state 403 is maintained. In contrast, when the received packet does not satisfy the termination target (i.e. TermTarget=UNSATISFIED), a state transition is performed into the normal state 404.

In the normal state 404, when a normally decoded packet satisfies the termination target, i.e. when the number of transmission times of the packet is equal to or less than the value of the termination target, it means that the AT has a sufficient transmission power, so that the BTS decreases the value of the PCT by a decrement of “NormalDown” (i.e. PCT=PCT−NormalDown). In contrast, when the BTS fails to decode the packet and the packet corresponds to the final packet, or when the number of transmission times of the packet exceeds to the value of the termination target although the BTS has successfully decoded the packet, it means that the AT has an insufficient transmission power, so that the BTS increases the value of the PCT by an increment of “NormalUp” (PCT=PCT+NormalUp). Meanwhile, when there is no received packet for a period of time, a state transition is performed into the no-data state 401.

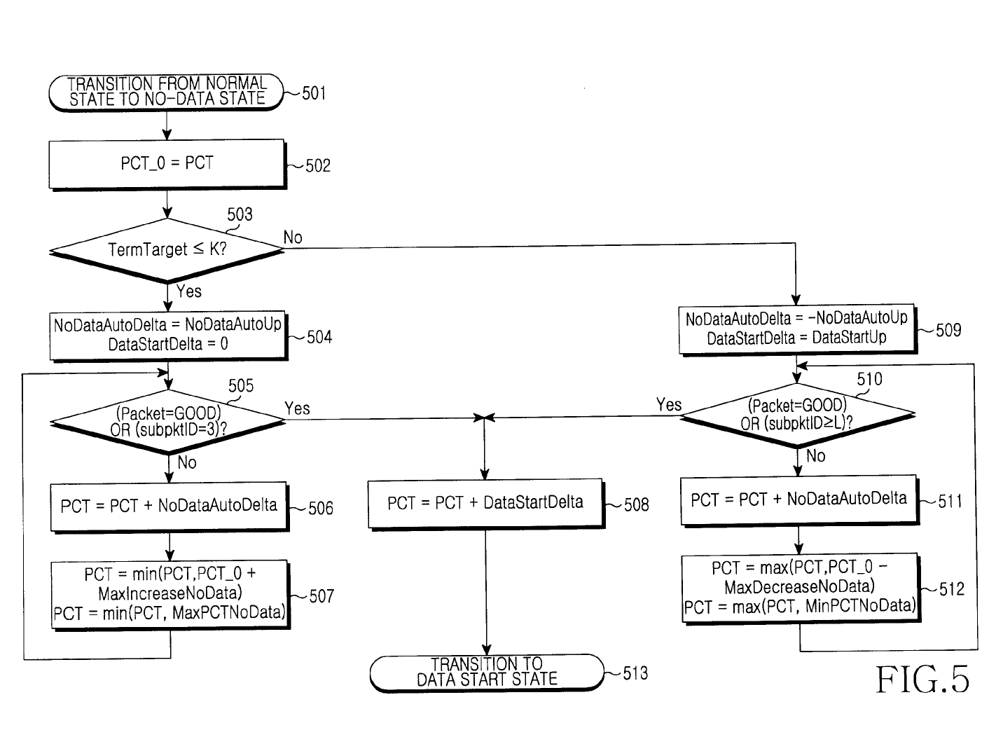

FIG. 5 is a flowchart illustrating an operation of the BTS in the no-data state according to an exemplary embodiment of the present invention.

When a state transition is performed into the no-data state because no packet is received for a period of time in the normal state (step 501), the BTS stores the current PCT value as PCT_{—}0 in step 502. In step 503, if a termination target is equal to or less than a value “K,” the BTS proceeds to step 504, and if it is not, the BTS proceeds to step 509. In this case, the value “K” functions to classify the operations in the no-data state according to termination targets, and has one value among a group of {0, 4, 8, 12, 16} according to the number of times of subpacket transmissions during four slots.

In step 504, since the termination target is equal to or less than the value “K,” the BTS sets the “NoDataAutoDelta” to the “NoDataAutoUp,” which is a positive value, so as to operate in the conventional outer-loop power control scheme, and sets the “DataStartDelta” to zero. In this case, the “NoDataAutoUp” is a constant value, which is determined by an update cycle of the PCT value, and an increasing speed of the PCT value in the no-data state. In step 505, the BTS determines if a packet has been normally decoded, or if the BTS has received subpackets up to the fourth subpacket (i.e. subpktID=3).

When the packet has been normally decoded, or when the BTS has received subpackets up to the fourth subpacket, the BTS proceeds to step 508. In step 508, the BTS increases the PCT value by the “DataStartDelta”, and proceeds to step 513 where the BTS is shifted into the data start state. In this case, since the value of the DataStartDelta is zero, the PCT value is maintained as it is. In contrast, when the packet has not been normally decoded, and the fourth subpacket has not been received, it means that there is no packet received from the AT, so that the BTS proceeds to step 506 where the BTS increases the PCT value by the “NoDataAutoDelta,” and then proceeds to step 507 where the BTS restricts the PCT value from excessively increasing in the no-data state by means of a maximum value. In step 507, the PCT value is calculated by Equation 2, in which the “MaxIncreaseNoData” represents the maximum increment of the PCT value in the no-data state based on PCT_{—}0, and the “MaxPCTNoData” represents the maximum value of the PCT value in the no-data state. After the PCT value is updated in steps 506 and 507, the BTS returns to step 505 so as to repeat the aforementioned procedure.

In step 509, the BTS defines the “NoDataAutoDelta” to be “−NoDataAutoUp” so that the “NoDataAutoDelta” becomes a negative value, and sets the “DataStartDelta” to the “DataStartUp.” In this case, the “DataStartUp” is a positive value, which is determined by an increment of the PCT value in the no-data state, a termination target, etc. In step 510, the BTS determines if a packet has been successfully decoded, and determines the ID of a received subpacket. When the packet has been normally decoded, or when the ID of the received subpacket is equal to or greater than the value of “L,” the BTS proceeds to step 508. In step 508, the BTS increases the PCT value by the “DataStartDelta,” and is shifted into the data start state. In contrast, when the packet has not been normally decoded, and the ID of the received subpacket is less than the value of “L,” the BTS proceeds to step 511. The “L” is a value for determining if a packet is received, and has one value among a group of {0, 1, 2, 3}.

In step 511, the BTS decreases the PCT value by adding the “NoDataAutoDelta” to the PCT value. In step 512, the BTS restricts the PCT value from excessively decreasing in the no-data state by means of a minimum value. The operation of step 512 is performed based on Equation 3 below.

PCT=max(PCT, PCT_{—}0−MaxDecreaseNoData, MinPCTNoData) (3)

In Equation 3, the “MaxDecreaseNoData” represents the maximum decrement of the PCT value in the no-data state based on PCT_{—}0, and the “MinPCTNoData” represents the minimum value of the PCT value in the no-data state. After the PCT value is updated in steps 511 and 512, the BTS returns to step 510 so as to repeat the aforementioned procedure.

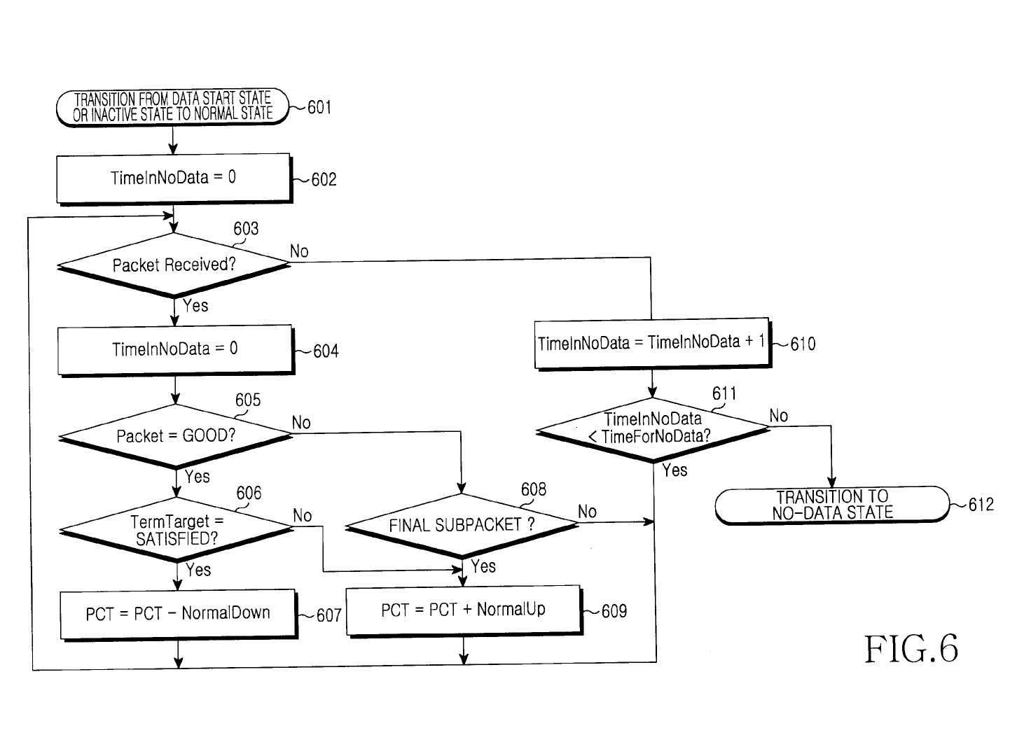

FIG. 6 is a flowchart illustrating an operation in the normal state according to an exemplary embodiment of the present invention.

When the BTS is shifted from the data start state or inactive state to the normal state in step 601, a timer called “TimeInNoData” is initialized in step 602. When there is a packet received by the BTS in step 603, the BTS proceeds to step 604. In contrast, when there is no packet received by the BTS in step 603, the BTS proceeds to step 610.

In step 604, since the BTS has received a packet, the BTS initializes the “TimeInNoData.” Then, in step 605, the BTS determines if the packet has been normally received. If the packet has been normally received, the BTS proceeds to step 606, and if it is not, the BTS proceeds to step 608.

In step 606, the BTS determines if a decoded packet has been received within a termination target. If the decoded packet has been received within the termination target, the BTS proceeds to step 607, and if it is not, the BTS proceeds to step 609. In step 607, since the BTS has successfully received the packet within the termination target, the BTS decreases the PCT value by the “NormalDown,” and then returns to step 603. In contrast, in step 609, since the BTS has failed to receive the packet within the termination target, the BTS increases the PCT value by the “NormalUp,” and then returns to step 603.

Meanwhile, in step 608, the BTS determines if the received packet corresponds to the final subpacket. If the BTS has received all subpackets up to the final subpacket, the BTS proceeds to step 609, and if the BTS has not received all subpackets, the BTS returns to step 603.

In step 610, since there is no packet received by the BTS in the normal state, the BTS increases the value of the “TimeInNoData” by one so as to measure a period of time for which there is no received packet. In step 611, the BTS compares the “TimeInNoData” with a “TimeForNoData.” When the “TimeInNoData” is less than the “TimeForNoData,” which is a preset time period, the BTS returns to step 603. In contrast, when the “TimeInNoData” is equal to or greater than the “TimeForNoData,” it means that data has not been received for a period of time, so that the BTS proceeds to step 612 where the BTS is shifted into the no-data state.

Meanwhile, when the no-data state is handled as shown in steps 509 to 512 of FIG. 5, the PCT value periodically decreases, so that when the AT resumes packet transmission in the no-data state, the BTS's reception performance for some initially transmitted packets may be degraded. Therefore, in order to alleviate such a reception performance degradation problem, the gains of the data channel and the reverse rate indicator (RRI) channel may be boosted.

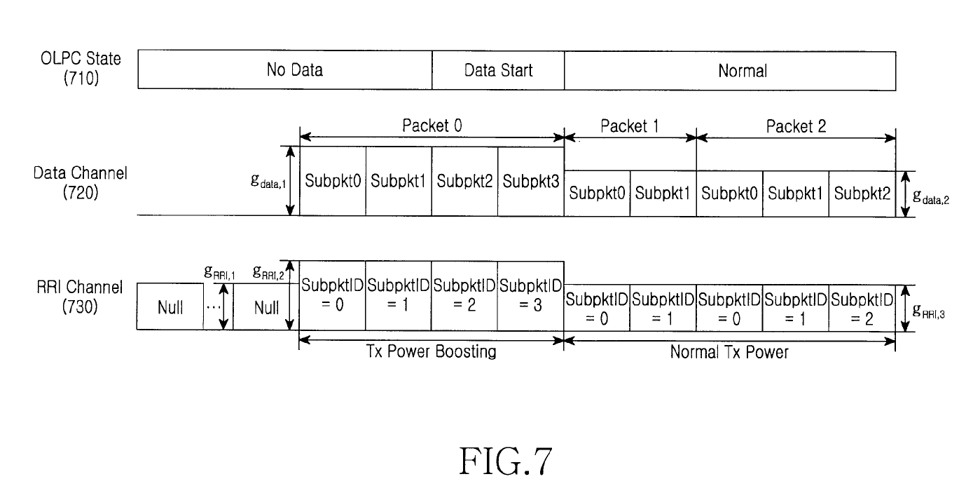

FIG. 7 is a view illustrating the method of boosting the gains of the data channel and the RRI channel in order to alleviate the reception performance degradation problem.

For convenience of description, the value of the “L” is assumed to be one. Reference numeral 710 indicates a state transition of the outer-loop power control algorithm. At first, the AT does not transmit data, which corresponds to the no-data state. When the AT starts transmitting Packet 0, and the BTS receives a first subpacket (i.e. Subpkt 0), a state transition is performed to the data start state according to the operation of step 510. When the BTS has not normally decoded Packet 0, even after receiving Subpkt 3 of Packet 0, a state transition is performed to the normal state.

Through a data channel 720, the AT starts transmitting Packet 0 in the no-data state. In this case, the gain of the data channel is set as “g_{data,1}”. When the transmission of Packet 0 has been finished in the no-data state, the data channel gain for the following transmission packets (i.e. Packet 1, 2, . . . ) is set as “g_{data,2}”. In this case, the “g_{data,2}” represents a data channel gain generally used in the normal state, and the “g_{data,1}” represents a channel gain used for the packet first transmitted in the no-data state, and is determined to a value equal to or greater than the “g_{data,2}”.

The AT notifies the BTS, via the RRI channel 730, of the transmission speed of subpackets transmitted through the data channel 720, and the IDs of the subpackets. During a slot where no packet is transmitted though the data channel 720, the AT transmits a “null” to notify the BTS that there is no transmitted packet, and in this case, the gain of the RRI channel 730 is set to “g_{RRI,1}”. When the AT starts transmitting a packet in the no-data state, the AT sets the channel gain for the RRI channel to “g_{RRI,2}”, and transmits information about the transmission speed and the subpacket IDs of Packet 0. For packets transmitted after the Packet 0, the AT sets the channel gain of the RRI channel to “g_{RRI,3}”, and transmits information about a transmission speed and subpacket IDs. In this case, the “g_{RRI,3}” represents an RRI channel gain generally used in the normal state, the “g_{RRI,1}” represents an RRI channel gain applied when a “null” is transmitted in a state where there is no transmitted packet, and is set to a value equal to or less than the “g_{RRI,3}”, and the “g_{RRI,2}” represents an RRI channel gain applied when the AT starts transmitting a packet for the first time in the no-data state, and is set to a value equal to or greater than the “g_{RRI,3}”.

When the no-data state is handled as shown in steps 509 to 512 of FIG. 5, a reception performance for a packet initially transmitted in the no-data state may be degraded. Therefore, in order to alleviate such a problem, the gains of the data channel and the RRI channel are boosted as shown in reference numerals 720 and 730. In addition, for the second packet and following packets, since the power control is normally performed in a state where a state transition is performed into the normal state via the data start state, the boosting is not applied to the gains of the data channel and the RRI channel. Through such a method, it is possible to minimize the reception performance deterioration of a packet initially transmitted in the no-data state.

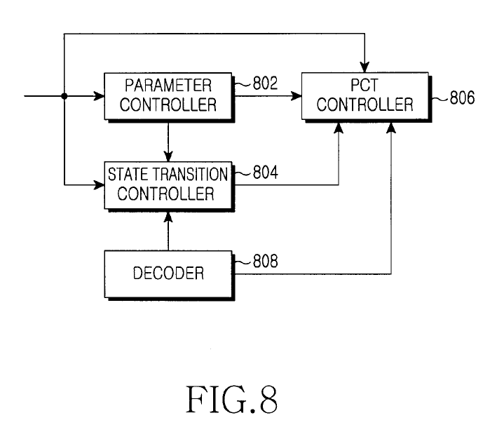

FIG. 8 is a block diagram illustrating the configuration of a power control apparatus according to an exemplary embodiment of the present invention.

A BTS notifies an AT of a preset termination target value. A parameter controller 802, which has received the termination target value, initializes parameters used to adjust a power control threshold by taking the received termination target value into consideration, and outputs information about the initialized parameters to a state transition controller 804 and a PCT controller 806. As described with reference to FIG. 4, the parameters include the “NoDataAutoDelta,” the “NormalDown,” the NormalUp,” the “TimeForNoData,” the “initial setpoint,” etc.

The state transition controller 804 determines state transition information by using not only the input termination target value, i.e. parameter information input from the parameter controller 802, but also information about a decoded packet input from a decoder 808, and then the determined state transition information to the PCT controller 806. That is, as described with reference to FIG. 4, the BTS is initialized to an inactive state at first, and is then shifted into the normal state when the outer-loop power control is started. Then, when there is no packet received for a period of time or more in the normal state, the BTS is shifted into the no-data state. When the BTS receives no packet for a period of time or more in the no-data state, and thus a dormancy time out condition is satisfied, the BTS is shifted into the inactive state. In contrast, when the BTS receives a packet in the no-data state, the BTS is shifted into the data start state.

The decoder 808 decodes all packets received via a reverse link, and outputs information about decoded packets to the state transition controller 804 and the PCT controller 806.

The PCT controller 806 increases or decreases the power control threshold, i.e. the PCT value, by using the input termination target value, the state transition information, and the information about the decoded packets.

Exemplary effects of the present invention, especially the effects obtained by the above-mentioned exemplary embodiments, will now be described.

When the power control method according to exemplary embodiments of the present invention is applied to a wireless mobile communication system, the threshold for power control can be efficiently adjusted, so that the cell capacity can increase while the link performance is stably maintained.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling, by a base transceiver station (BTS), transmission power of an access terminal (AT) in an outer-loop power control scheme in a wireless mobile communication system, the method comprising:
when a packet is not received from the AT for a period of time in a normal state where a call is established between the BTS and the AT, performing a state transition into a no-data state, and periodically decreasing a power control threshold value by a first value; and
when the BTS begins receiving a packet from the AT in the no-data state, increasing the power control threshold value by a second value, and performing a state transition into a data start state.

2. The method as claimed in claim 1, wherein the packet comprises at least two subpackets.

3. The method as claimed in claim 1, further comprising maintaining the power control threshold value at a third value when the power control threshold value decreases to a value equal to or less than the third value.

4. The method as claimed in claim 2, further comprising:
receiving a packet from the AT in the normal state;
determining if the packet is normally decoded;
decreasing the power control threshold value by a fourth value when the packet has been successfully decoded and the number of transmission times of the packet is equal to or less than a number of transmission times;
determining if the packet corresponds to a final subpacket when the decoding of the packet fails; and
increasing the power control threshold value by a fifth value, when at least one of the packet corresponds to the final subpacket and the number of transmission times of the packet exceeds the number of transmission times.

5. The method as claimed in claim 1, further comprising notifying the AT of a difference between a data channel gain used for a first transmitted packet and a data channel gain used for transmission of packets other than the first transmitted packet.

6. The method as claimed in claim 1, further comprising notifying the AT of a difference between a reverse rate indicator (RRI) channel gain used for a first transmitted packet and an RRI channel gain used for transmission of packets other than the first transmitted packet.

7. A method for controlling power by a base transceiver station (BTS) in a wireless mobile communication system, the method comprising:
comparing a number of times of packet reception from an access terminal (AT) with a number of packet transmission times during a data start state where the BTS receives a packet from the AT;
decreasing a power control threshold value by a first value when the number of times of the packet reception from the AT is equal to or less than the number of packet transmission times; and
performing a state transition into a normal state where a call is established between the BTS and the AT when the number of times of the packet reception from the AT exceeds the number of packet transmission times.

8. A method for controlling power by a base transceiver station (BTS) in a wireless mobile communication system, the method comprising:
altering a power control threshold value by a first value at an interval during a no-data state where the BTS is linked to an access terminal (AT) and a transmitted/received packet does not exist; and
increasing the power control threshold value by a second value and performing a state transition into a data start state when packet transmission/reception is started between the BTS and AT.

9. The method as claimed in claim 8, wherein the altering of the power control threshold by the first value comprises at least one of increasing and decreasing the power control threshold by the first value.

10. The method as claimed in claim 9, wherein the first value comprises at least one of a positive value and a negative value according to a number of packet transmission times.

11. The method as claimed in claim 10, wherein the second value comprises a positive value when the first value comprises a negative value, and further wherein the second value comprises zero when the first value comprises a positive value.

12. A method for controlling power by a base transceiver station (BTS) in a wireless mobile communication system, the method comprising:
receiving a packet from an access terminal (AT) in a normal state where a call is established between the BTS and the AT;
determining if the packet is normally decoded;
decreasing a power control threshold value by a first value when the packet has been successfully decoded and the number of transmission times of the packet is equal to or less than a number of transmission times;
determining if the packet corresponds to a final subpacket when the decoding of the packet fails; and
increasing the power control threshold value by a second value, when at least one of the packet corresponds to the final subpacket and the number of transmission times of the packet exceeds the number of transmission times.

13. An apparatus for controlling power in a wireless mobile communication system, the apparatus comprising:
a state transition controller for outputting state transition information for a state transition control by using at least one of a number of packet transmission times, parameter information and information about decoded packets; and
a power control threshold (PCT) controller for receiving the number of packet transmission times, the parameter information, the information about decoded packets, and the state transmission information, and for adjusting a power control threshold value.

14. The apparatus as claimed in claim 13, further comprising:
a decoder for outputting the information about the decoded packets; and
a parameter controller for outputting the parameter information.

15. The apparatus as claimed in claim 14, wherein the information about the decoded packets includes at least one of the number of packet transmission times by an access terminal (AT) and information about whether a packet has been successfully decoded.

16. The apparatus as claimed in claim 14, wherein the parameter information comprises:
information about a first parameter for altering the power control threshold value in a first state;
information about a second parameter for decreasing the power control threshold value in a second state;
information about a third parameter for increasing the power control threshold value by zero or more when a state transition is performed from the first state to the second state;
information about a fourth parameter for decreasing the power control threshold value in a third state; and
information about a fifth parameter for increasing the power control threshold value in the third state.

17. The apparatus as claimed in claim 16, wherein the first state corresponds to a no-data state in which a link to an AT is maintained but a transmitted/received packet does not exist.

18. The apparatus as claimed in claim 16, wherein the second state corresponds to a data start state in which a packet is at least one of transmitted to and received from the AT.

19. The apparatus as claimed in claim 16, wherein the third state corresponds to a normal state in which a call with an AT is established.

20. The apparatus as claimed in claim 16, wherein the PCT controller compares the number of times of packet transmission by an AT with the number of packet transmission times, selects one of the fourth and fifth parameters according to a result of the comparison, and controls the PCT value using the selected parameter.
